(19) United States
(12) Patent Application Publication
(10) Pub. No.: US 2017/0209888 A1
(43) Pub. Date: Jul. 27, 2017

(54) Rack for Painting, Stacking and Drying Heavy Doors

(71) Applicant: Jake B. Schaerer, San Diego, CA (US)

(72) Inventor: Jake B. Schaerer, San Diego, CA (US)

(21) Appl. No.: 15/007,057

(22) Filed: Jan. 26, 2016

(51) Int. Cl. B05B 13/02; A47B 81/00

(52) U.S. Cl. CPC B05B 13/0285; A47B 81/00

(57) ABSTRACT

This invention is a sturdy door rack that can easily be disassembled for shipping and storage and reassembled for use. It comprises stackable blocks that fit over each other in Leggo™ fashion to form supporting columnar stacks each stack supported by a base plate. Each block is configured on its top surface with a groove having a rectangular cross section. A cylindrical anchor inserted inside each groove is screwed into the edge of a door, thereby supporting the door. The rack can be configured with four stacks, thereby supporting the door at four points. The rack can also be configured with two stacks, thereby supporting the door at two points, thereby allowing the door to be easily rotated around an axis defined by these two points. Anchors located between two blocks in a stack are held firmly in place by the blocks, thereby achieving greater mechanical strength.

### FIELD OF THE INVENTION

This invention relates to racks used to support heavy doors while they are prepped and painted and when they are stacked to dry in a horizontal position. Prepping is defined as activities performed before painting such as sanding and taping.

### BACKGROUND

Refinishing a door is time consuming labor. Typically this work involves activities such as sanding, painting, varnishing and drying the door. Placing the door in a vertical position during this work is problematic. Sprayed paint may reach surrounding objects and debris from the floor may foul the wet paint on the door. Wet paint may run down a vertical door creating unsightly tracks. It is more difficult for a painter to work on a vertical door than on a horizontal door.

Ideally a door should be held in a horizontal position while it is being refinished. In addition, both sides of the door should be easily exposed to be worked on, and when painted, the wet paint should not be marred by the holding mechanism.

A problem that emerges when multiple doors are painted is that a large surface area is needed to store the doors while they are drying. Therefore, there is a need to store the drying doors in a stack.

Another problem of significance is that freshly painted doors should be allowed to dry in a location removed from the one where doors are sanded and painted to avoid unwanted dust and paint settling on them and marring their surface.

Painting racks for heavy doors have special requirements. Assume a weight of 100 lbs per door and a stack of 10 doors. The rack should therefore be capable of supporting a 1000 lbs weight. Rack construction should therefore take weight into account.

The cost incurred to merchants for shipping racks to customers should also be a consideration. Given the structural requirements of racks to support heavy doors and their volume in an assembled state, the shipping cost incurred by merchants can be prohibitive. Therefore, the invention should also minimize the weight of the rack and its volume in its disassembled state, leaving the assembly task to the customer.

None of the prior art offers the functionality, flexibility of use, simplicity and economy of this invention. Further features, aspects, and advantages of the present invention over the prior art will be more fully understood when considered with respect to the following detailed description claims and accompanying drawings.

Further features, aspects, and advantages of the present invention over the prior art will be more fully understood when considered with respect to the following detailed description and claims.

### SUMMARY OF THE INVENTION

This invention is a sturdy door rack that can easily be disassembled for shipping and storage and reassembled for use. Essentially, it comprises stackable blocks that fit over each other in Leggo™ fashion to form supporting columnar stacks. The invention also comprises anchors adapted to be screwed into the edges of a door. The anchors fit inside grooves configured in the blocks. Base plates are adapted to be positioned at the bottom of the columns.

The door rack can be configured to form four stacks of blocks to support the door at four points. Alternatively, for easy rotation of the door around an axis, the rack can be configured in two stacks to support the door at two points that define an axis of rotation going through the door's center of gravity. In practice these two stacks can each include a single block, each block supported by a base plate.

The rack also includes anchors, each anchor being formed by a rod terminated at one end with a wood screw or some other form of pointed end, and at its other end with a cap comprising a bolt head or a screw head. To facilitate manual handling and flipping of the door, the rod can be made of a central cylindrical core covered by a rotatably loose tubular sleeve. The wood screw and the rod can be solidly attached or can be joined by means of a male/female threaded connector. Similarly, the cap and the rod can be solidly attached or can be joined by means of a male/female threaded connector.

Each block has on its top surface a groove into which the anchors are inserted. When blocks are stacked, anchors between adjacent blocks are held firmly in place. The groove has a rectangular cross section and is typically longer than wide to provide pitch and yaw stability to the anchor. The width of the groove is significantly larger than the diameter of the rod to provide limited horizontal play and account for positional inaccuracy of the anchor on the edge. However the height of the groove is the same as the diameter of the rod to hold the anchors snuggly in place, completely restricting any pitch movement when the anchors are inserted between two blocks in a stack, thereby providing greater mechanical strength to the anchors.

The blocks are stacked Leggo™ style on top of each other. They are equipped on their lower surface with pins, and on their upper surface with holes positioned to mate with the pins of an adjacent block. Typically each block could have two pins and two holes, or four pins and four holes. The length of the pins can be longer than a typical Leggo™ pin for greater stability.

The bottom of the stack includes a base plate with the appropriate hole configuration to mate with the bottom block of the stack. The base plate can be screwed, nailed, glued or pinned to the bottom block. The base plate and the bottom block can also be fabricated from a single slab of material, forming a single piece. The base plate may also include a hole to facilitate its attachment to a supporting structure such as a saw horse. The base plate can also be attached to a supporting structure by means of a vise.

The rack could include four multi-block columnar stacks to support the door at four points, for example when the doors need to be stacked for drying. The rack could include four single-block columns to support the door at four points, for example when the doors need to be prepped or painted. In this configuration, the base plate would be attached by screw, bolt or vise to a supporting structure such as a saw horse to elevate the door and permit its flipping upside down.

The rack could also include two single-block columns to support the door at two points, for example when the door needs to be axially rotated for prepping and painting. In this configuration, the base plate would also be attached by screw, bolt or vise to a supporting structure such as a saw horse to elevate the door and permit its flipping upside down. In this case, it is advantageous to add a cylindrical concave internal groove inside the rectangular groove to hold the anchor in place but yet facilitate the rotation of the door.

Rotation of the door can be limited by means of a stop bar horizontally inserted through a hole in one of the blocks, and making contact with a stop anchor attached to the edge of the door.

Base plates of different sizes are provided, each size appropriately designed for the way the base is used. For example, large base plates are used to support multi-block self standing columnar stacks as employed in drying. Narrow elongated base plates are more appropriate in a two-column configuration, when each column includes a single block, as employed in prepping or painting. In this arrangement, the base plates are supported by a supporting structure such as a saw horse. The anchors on top of the two columns define an axis of rotation around which the door can be pivoted.

Narrow short base plates are more appropriate in a four-column configuration, when each column includes a single block, as employed in prepping or painting. In this arrangement, the base plates are supported by a saw horse. In this arrangement, the base plates are also supported by a supporting structure such as a saw horse.

The rack can only carry a maximum weight, and therefore, the maximum height of the rack should be limited for safety reasons. The top block on each stack is identifiable by means of shape, color, engraving or printing to indicate that the maximum stack height has been reached.

An advantage of this invention is its flexibility in making a large number of configurations possible. For example if the total number of blocks available is 16, one could use only two blocks to support a door along an axis through its center of gravity. Alternatively, one could use four blocks to support the door at four points. Yet alternatively, one could use eight blocks, forming four stacks of two blocks each. Yet one could use twelve blocks forming four stacks of three blocks each. Yet one could use all sixteen blocks forming four stacks each having four blocks. In practice, the rack kit would typically include 40 blocks allowing the user to form four stacks with up to 10 blocks each. The maximum height of a stack is determined by the combined weight of the doors and the mechanical strength of the blocks and anchors. Therefore the rack kit contains at least four blocks, each block is configured to be stackable. “Some” of the blocks can be arranged to form at least two stacks. In the previous sentence the word “some” means “all” or “less than all” indicating that all blocks may be used, yet that not all of the blocks need to be used. Equivalently, the expressions “some” and “some or all” are meant to be identical when they refer to the number of blocks from the kit being used to form stacks.

### BRIEF DESCRIPTION OF THE DRAWINGS

FIG. 1 illustrates a single stackable block showing four pins on its underside and four holes on its upper side for easy stackability.

FIG. 2 illustrates a single stackable block showing two pins on its underside and two holes on its upper side for easy stackability.

FIG. 3 shows an anchor comprising a rod terminated by a wood screw at one end and a bolt or screw cap at the other end.

FIG. 3A shows an exploded view of an anchor.

FIG. 3B shows an anchor in which the rod comprises an inner cylindrical core covered by a rotatably loose tubular sleeve.

FIG. 3C provides an exploded view of the anchor with a tubular sleeve.

FIG. 4 provides an exploded view of an anchor, a block and a base plate.

FIG. 5 provides a front cross-section of a stack with anchors and base plate.

FIG. 6 provides a side cross-section of a stack with anchors and base plate.

FIG. 7 provides a front cross-section of a rack supporting a door.

FIG. 8 provides a side cross-section of a rack supporting a door.

FIG. 9 is an exploded cross sectional side view of the rack holding a set of doors. In this version each block has four pins 2 at the bottom and four holes 3 on top.

FIG. 10 is an exploded cross sectional side view of the rack holding a set of doors. In this version each block has two pins 2 at the bottom and two holes 3 on top.

FIG. 11 shows a rack pivotably supporting a door. Rotation of the door is stopped by a stop bar traversing the supporting block and making contact with stop anchors.

FIG. 12 provides an exploded view of a block, a base plate, and a stop bar used in a two columnar rack configuration.

FIG. 13 provides a front view of a pivotably supported door in a two columnar rack configuration.

FIG. 14 provides a perspective view of a door supported by four single-block columns. This configuration is suitable for prepping or painting and the door can be manually flipped by two men.

FIG. 15 provides an exploded view of the base plate and bloc configuration used in FIG. 14.

FIG. 16 provides a front view of a rack configuration suitable for prepping or painting, and using four supporting single-block columns.

### DETAILED DESCRIPTION

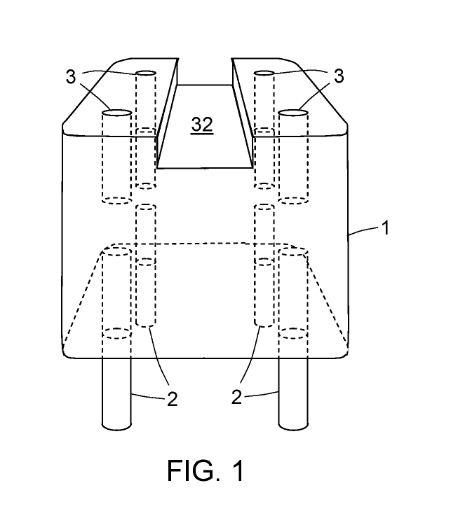

This invention will be better understood in light of the drawings. The rack in disassembled form comprises a small set of elements forming a construction set or construction kit, which can be compactly stored, easily shipped and quickly assembled. As shown in FIG. 1, the rack comprises the following components.

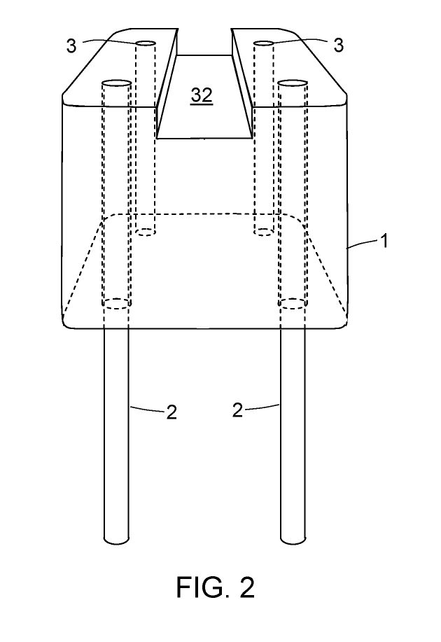

The first set of components is a number of stackable blocks, each block essentially being polyhedra having parallel top and bottom surfaces. FIG. 1 shows a block 1 approximately cubic in shape. The block 1 is equipped on its bottom face with at least one pin 2 and on the top face with at least one hole 3. The holes are positioned to receive a corresponding pin when the blocks are stacked. This block configuration allows the blocks to be stacked in Leggo™ fashion thereby forming four sturdy columns. One should note that the pins 2 can be longer than a conventional Leggo™ pin to provide greater stability. Typically a block 1 could comprise four pins 2 as shown in FIG. 1 or four pins as shown in FIG. 2.

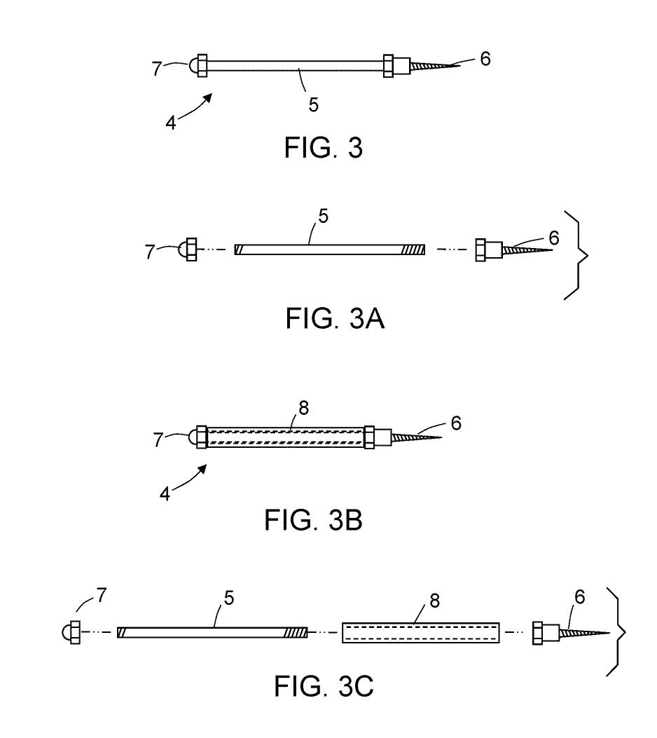

The second set of components shown in FIG. 3 includes anchors 4. Each anchor 4 comprises a cylindrical rod 5 preferably made of hard stainless steel and terminated at one of its ends with a wood screw 6 and at its other end with a bolt head or screw head 7. FIG. 3A shows an anchor 4 in an exploded view. In FIG. 3B a tubular sleeve 8 is inserted over the rod 5. FIG. 3C provides an exploded view of the anchor 4 with the tubular sleeve 8. The tubular sleeve 8 allows the rod to rotate easily in a handler's hands when a door is manually flipped.

The anchors 4 can be built from easily available components. The rod 5 can be fully threaded or threaded only at its ends. One end of the rod 5 is attached to a cap 7 with a female thread, and the other end of the rod 5 is attached to a wood screw 6 also with a female thread. Alternatively the cap/rod combination could simply be a single piece, in the shape of a bolt adapted to fit into the female end of the wood screw 6.

The screws 6 allow the rods 5 to be screwably attached to edges of a door, typically to the upper and lower edges to avoid leaving visible marks on the door. The bolt heads or screw heads 7 allow the user to drive the screws.

The anchors 4 fit inside grooves 32 configured in the top face of each block 1. The grooves 32 are shaped to hold the rod portion 5 or the anchors 4. The depth of each groove 32 is approximately the same as the diameter of the rods 5 thereby allowing the rods 5 to fit snuggly between adjacent blocks 1 in the stack. In addition, the width of the grooves 32 is significantly wider than the diameter of the rods 5, thereby providing some horizontal play to allow for small horizontal inaccuracies in the placement of the anchors along the door's edges.

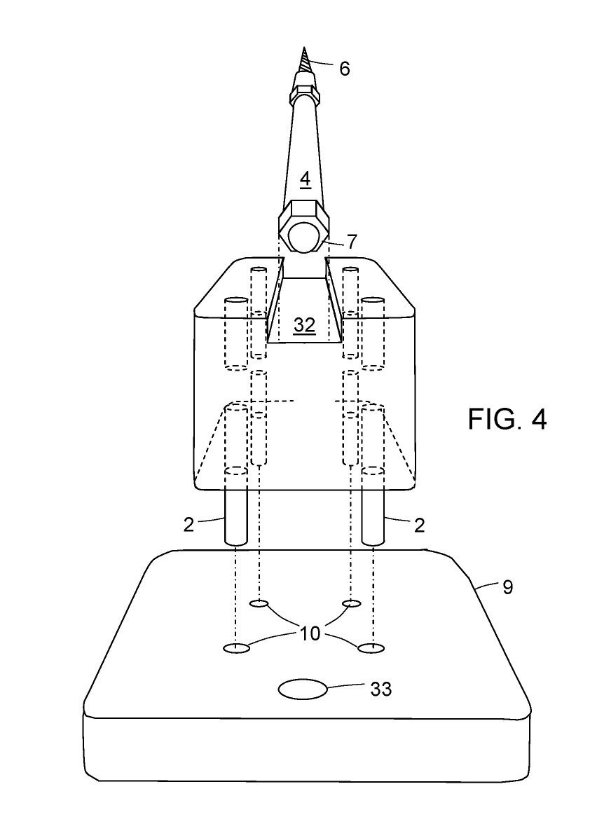

The third set of components shown in FIG. 4 is four base plates 9 designed to be positioned underneath the four block columns. The plates 9 are configured with holes 10 positioned to receive the pins 2 from the blocks 1 at the bottom of the columns. The base plates 9 provide vertical stability to the columns. The base plate 9 may be configured with a hole 33 to allow the plate 9 to be anchored to a supporting structure by means of a bolt or a screw. Alternatively, each base plate 9 could be formed of a single solid piece incorporating the bottom block 1 of each stack. Furthermore, alternatively, each base plate 9 could be permanently attached to the bottom block 1 of each stack, by means of screws, nails or glue.

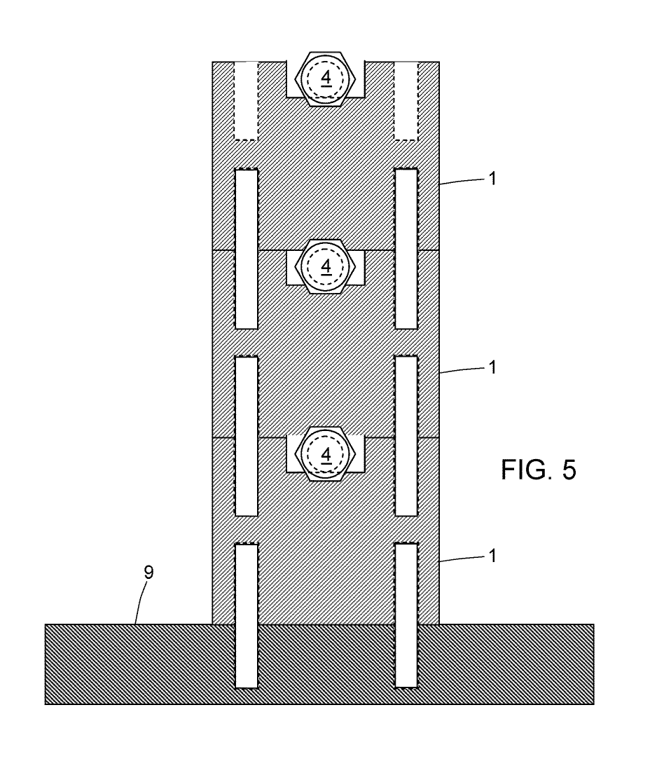

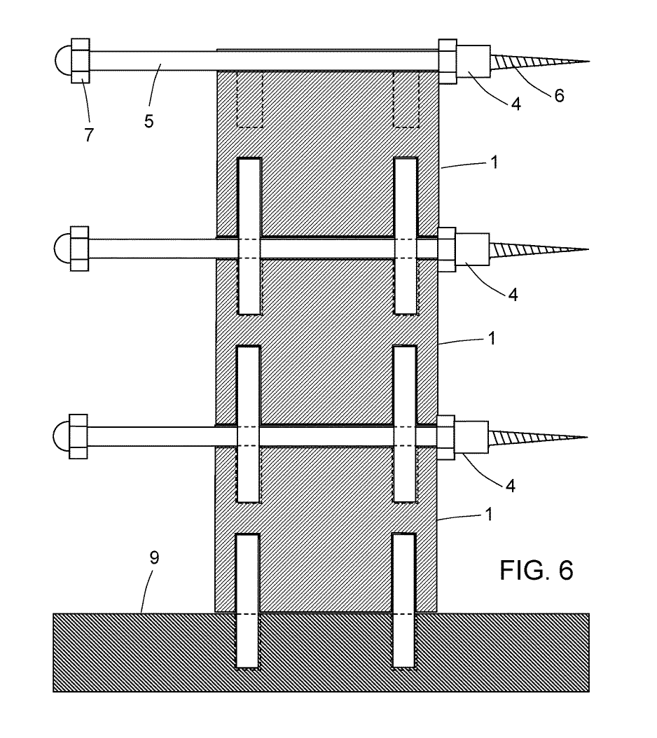

FIGS. 5 and 6 show an assembly of three blocks 1 mounted on their base 9 with anchors 4 inserted between the blocks 1. FIG. 4 shows the assembly in front-view cross-section and FIG. 5 shows the assembly in side-view cross-section.

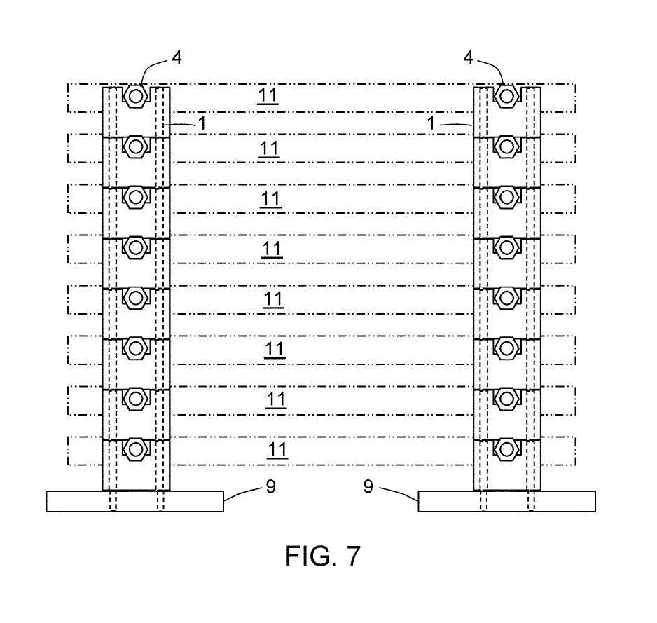

FIG. 7 shows a front-view of a stack of doors 11 in horizontal position and supported by columns of blocks 1. FIG. 7 shows a side-view of a stack of doors 11 supported by columns of blocks 1.

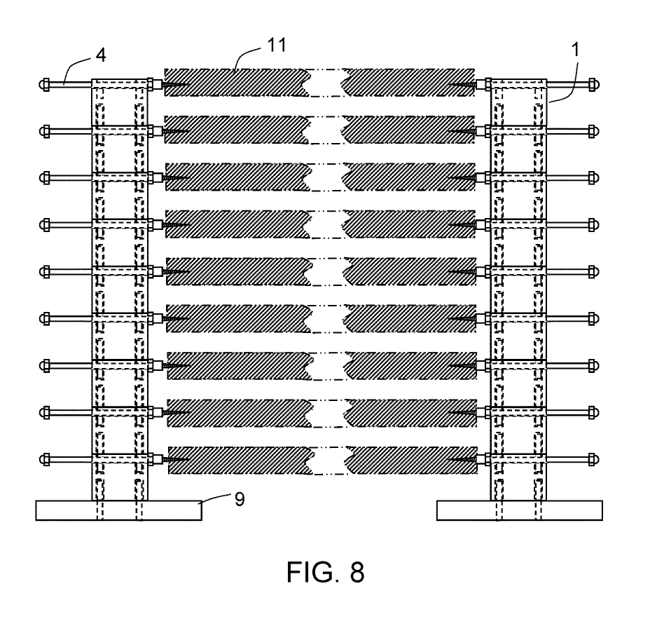

FIG. 8 shows a cross sectional side-view of a stack of doors 11 in horizontal position and supported by columns of blocks 1.

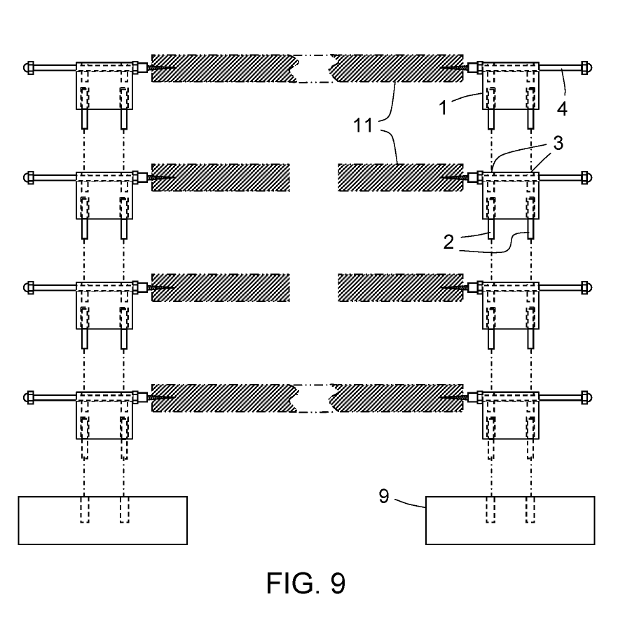

FIG. 9 is an exploded cross sectional side view of the rack holding a set of doors. In this version each block has four pins 2 at the bottom and four holes 3 on top.

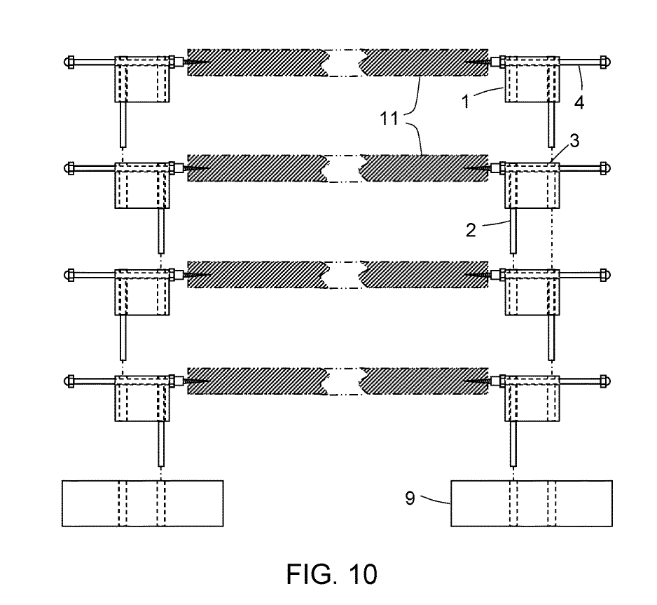

FIG. 10 is an exploded cross sectional side view of the rack holding a set of doors. In this version each block has two pins 2 at the bottom and two holes 3 on top.

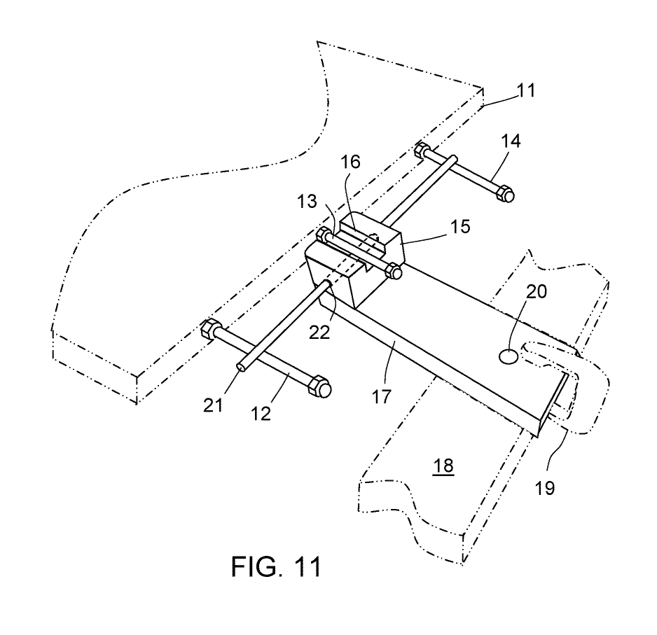

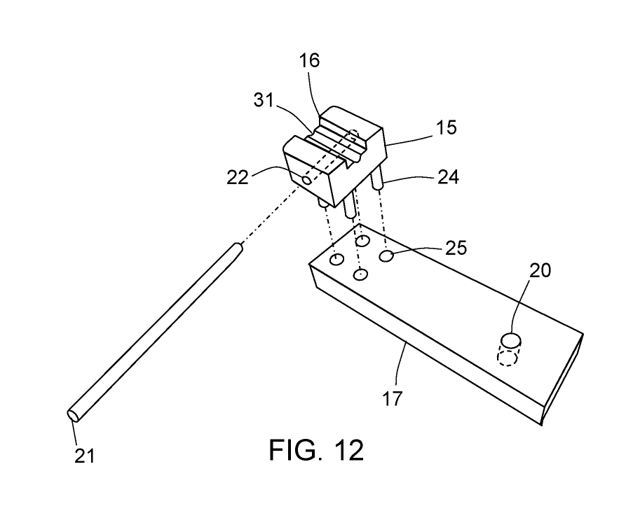

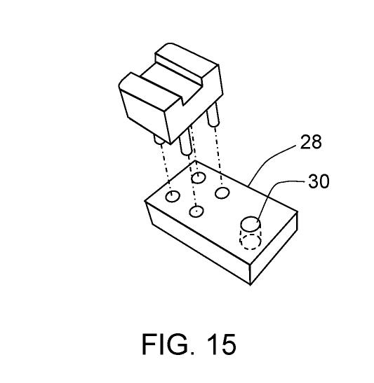

Prepping or painting requires that the door be flipped. This can be accomplished by the implements illustrated in FIGS. 11-16. As shown in FIG. 11 three anchors 12, 13, 14 are inserted on two opposite edges of the door 11. The central anchor 13 serves as an axis of rotation. This central anchor 13 is supported by a block 15 and is positioned inside the top groove 16 of the block 15. The top groove 16 can be configured with an additional deeper internal cylindrical groove 31 designed to hold the anchor 13 in place. The block 15 rests on a platform 17. The block can be attached to the platform 17 by means of pins, screws, nails or glue. Alternatively, the block 15 and platform 17 can be made of the same solid material forming a single piece.

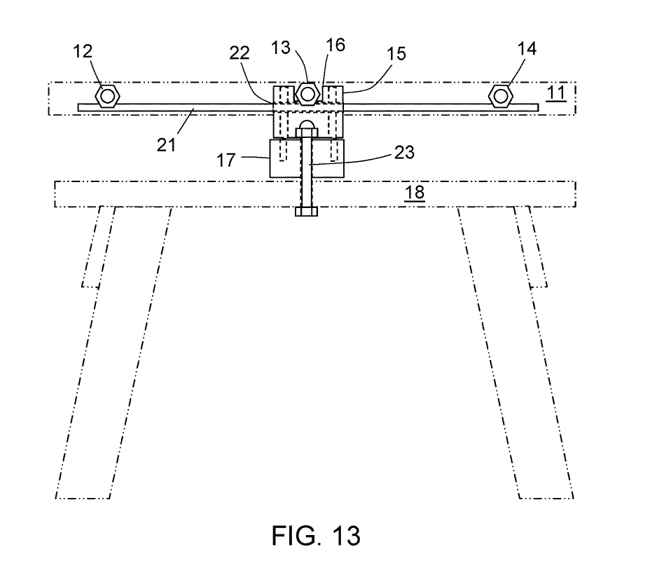

The platform 17 is supported by a carpenter wooden saw-horse 18. The platform 17 can be clamped to the horse 18 by means of a vise 19 as shown in FIG. 11. Alternatively, the platform 17 can be screwed to the horse 18 by inserting a bolt 23 through the hole 20 as shown in FIG. 13.

The side anchors 12 and 14 are used to stop the door from rotating. This is done by inserting a bar 21 horizontally through the hole 22 in the block 15 such that the bar 21 makes contact with one or two of the side anchors 12 and 14. To rotate the door 11, the bar 21 is slid inside the hole 22 to break contact with the side anchors 12 and/or 14, the door 11 is manually rotated by manually grabbing anchors 12 and/or 14. The bar 21 is then slid back into the hole 22 to make contact with anchors 12 and/or 14 and secure the door 11 in its new position.

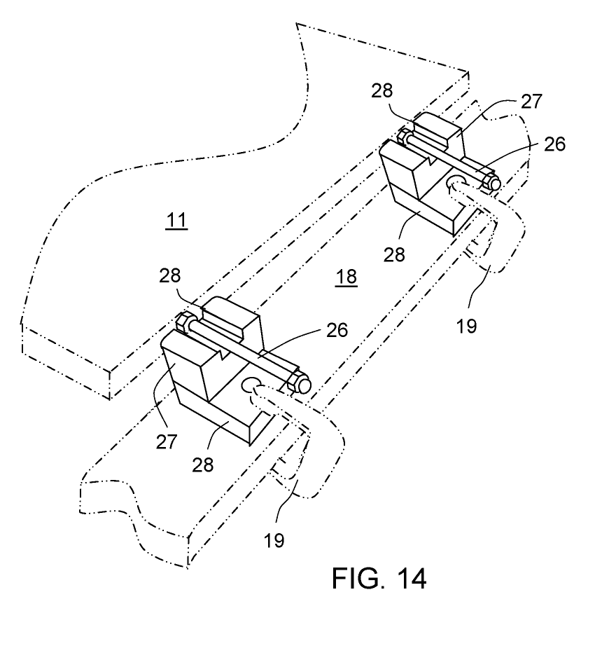

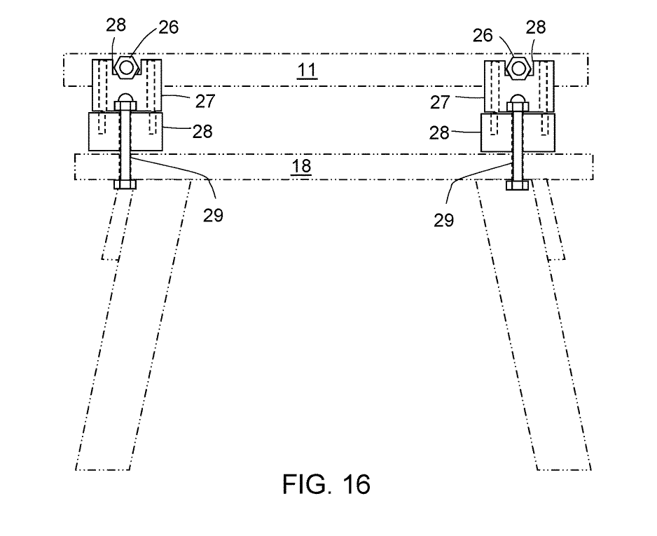

An alternative configuration for rotating a door for prepping or painting is shown in FIG. 14-16. Two anchors 26 are inserted on two opposite edges of the door 11. Each anchor 26 is supported by a block 27 and is positioned inside the top groove 28 of the blocks 27. Each block 27 rests on a platform 28 which is supported by a saw-horse 18. The platform 28 can be clamped to the horse 18 by means of a vise 19 as shown in FIG. 14. Alternatively, the platform can be screwed to the horse by inserting a bolt 29 through the hole 30 as shown in FIG. 16.

To rotate the door 11, two men are required, one at each of the two supported edges. They flip the door by grabbing the anchors 26 and turning the door 11 upside down.

Many variations of the above design are possible. For example the blocks 1 do not have to be cubes. They could be polyhedra with parallel top and bottom surfaces, adequate for stacking. In addition, the grooves 32 do not have to be on the top surface of the block 1. They could be placed on the bottom surface. They could also be configured partially in the top surface and partially in the bottom surface. The blocks 1 can be made of wood, plastic or metal.

The pins 2 could range from a minimum of one pin per block 1 to six pins, the optimal number being between two and four pins per block 1. The pins 2 could be made of metal, or could simply be shaped in the block in the manner of a Leggo™ block.

If two pins per block are used, the pins 2 can be positioned on the same side of the block, for example both near the door or both far from the door as shown in FIGS. 2 and 4. Alternatively, the pins can be positioned diagonally across the block's face, one pin near the door and one pin far from the door. Adjacent blocks on the stack would carry pins on alternate diagonals.

The pins 2 could be permanently mounted in the blocks, for example with glue. The pins could also be screwably inserted or force-fitted into the blocks. Insertion of the pins into the blocks 1 can be performed by the manufacturer or by the user.

The base plates 9, 17 and 28 could be manufactured independently of the blocks. Alternatively, they could be permanently attached to the bottom block, the method of attachment being for example glue, screws or nails. Another variation is to cast or form the base plate and the bottom block from a single piece of material. Base plates of different sizes are provided, each size appropriately design for the way the base is used. For example, a large base plate 9 is used to support self standing stacks as in FIGS. 7 and 8. A narrow elongated base plate 17 is used as shown in FIG. 9 when it is supported by a saw horse and the door is painted or prepped and needs to be rotated around an axis as formed by anchors 13. A short narrow base plate 28 can be used as shown in FIG. 14 when it is supported by a saw horse and the door is painted or prepped and is rotated by flipping it by hand.

The number of doors safely stacked on a rack is limited by the mechanical strength of the rack. It is therefore suitable to limit the height of a stack of blocks. This can be done by configuring the top block without any holes on its top surface and clearly indicating that this is the top block for example by shape, print or color to remind the user not to exceed the recommended height.

This invention has several advantages over the prior art including 1) a sturdy block construction that can support heavy doors 2) The ability to be reconfigured into a single door carrier or a multiple door stack carrier thereby addressing respectively the tasks of painting and stacking doors and 3) the ability to be easily disassembled and reassembled for storage and shipping purposes.

While the above description contains many specificities, the reader should not construe these as limitations on the scope of the invention, but merely as exemplifications of preferred embodiments thereof. Those skilled in the art will envision many other possible variations within its scope. Accordingly, the reader is requested to determine the scope of the invention by the appended claims and their legal equivalents, and not by the examples which have been given.

I claim:

1. A painting rack for supporting a door at at least two points along said door's edges, comprising:
a. at least four blocks, said blocks configured to be stackable, some or all of said blocks forming at least two stacks, each stack comprising at least one block and having a bottom block;
b. each block having a top surface and a bottom surface, and shaped on its said top surface with a groove, said groove having a length and a cross section with a depth and a width, said groove's length being greater than said groove's width;
c. at least two anchors, said anchors comprising:
i. a cylindrical rod having a length and also having a diameter essentially equal to said depth of said groove;
ii. a wood screw attached to a first end of said rod; and
iii. a bolt head or screw head forming a cap attached to a second end of said rod;
d. each said anchor positioned inside said groove of each said block, said rod being parallel with said groove, said rod's length being essentially the same as said groove's length, said width of said groove significantly larger than said diameter of said rod, thereby allowing horizontal play in the position of said rod; and
e. at least two base plates, each said base plate supporting said bottom surface of said bottom block of said stack.
said wood screws inserted into said edges of said door, thereby supporting said door.

2. The painting rack of claim 1 wherein
a. each said stack comprises at least two said blocks including a top said block and at least one lower said block;
b. any said anchor carried in said groove of said at least one lower block being dubbed lower anchor, said lower anchor being held snuggly in place between two said blocks in said stack and being prevented from rotating around a horizontal axis perpendicular to said groove;

3. The painting rack of claim 1 wherein some of said blocks are equipped on their said bottom surface with pins, and some of said blocks are configured on their top surface with holes, said holes and said pins being positioned to fit each other when said blocks are stacked.

4. The painting rack of claim 3 wherein said bottom block is equipped on its said bottom surface with said pins, and said base plate is configured with holes positioned to match said pins of said bottom block.

5. The painting rack of claim 1 wherein said bottom block is attached to said base plate by screws, nails or glue.

6. The painting rack of claim 1 wherein said bottom block and said base plate consist of a single solid piece of material.

7. The painting rack of claim 1 wherein said base plate is configured with a hole and attached to a supporting structure by means of a screw, a bolt, or a nail.

8. The painting rack of claim 1 wherein said base plate is attached to a supporting structure by means of a vise.

9. The painting rack of claim 1 wherein said rod comprises an inner cylindrical core covered by a rotatably loose tubular sleeve.

10. The painting rack of claim 1 wherein said rods and said wood screws are screwably attached to each other.

11. The painting rack of claim 1 wherein said rods and said wood screws form a single solid piece.

12. The painting rack of claim 1 wherein said rod and said cap are screwably attached to each other.

13. The painting rack of claim 1 wherein said rod and said cap form a single solid piece.

14. The painting rack of claim 1 comprising four said stacks, four said base plates, at least four said blocks, and at least four said anchors, said door being supported at four points along its said edges.

15. The painting rack of claim 1 comprising four said stacks, four said base plates, four said blocks, and four said anchors, said door being supported at four points along its said edges.

16. The painting rack of claim 1 comprising two said stacks, two said base plates, two said blocks, and at least two said anchors, said door being supported at two points on its said edges, said points defining an axis of rotation essentially traversing a center of gravity of said door, around which said door can be rotated.

17. The painting rack of claim 16 wherein said grooves of said blocks includes an additional deeper internal groove, said additional groove being cylindrically concave and having a cylindrical axis parallel to said anchor, said internal groove restricting movement of said anchor in the pitch and yaw direction but allowing rotation of said anchor around said cylindrical axis.

18. The painting rack of claim 17 comprising:
a. at least one stop said anchor;
b. at least one said block configured with a hole drilled horizontally, perpendicular and below said groove;
c. a stop bar inserted into said horizontal hole;
d. said stop bar preventing rotation of said door by making contact with at least one said stop anchor attached to one of said edges of said door.

19. The painting rack of claim 1 wherein four of said blocks, designated as top blocks, having a top surface unsuitably configured for stacking, and identifiable by their shape or by engraving, coloring or printing to indicate that the maximum recommended height of said stacks has been reached for safe operation.
